(19) United States
(12) Patent Application Publication
(10) Pub. No.: US 2018/0365401 A1
(43) Pub. Date: Dec. 20, 2018

(54) MULTI-MODAL BASED USER AUTHENTICATION APPARATUS AND METHOD USING BIO SIGNAL

(71) Applicant: Korea Internet & Security Agency, Seoul (KR)

(72) Inventors: Saewoom LEE, Seoul (KR); Jason KIM, Seoul (KR)

(73) Assignee: Korea Internet & Security Agency, Seoul (KR)

(21) Appl. No.: 15/816,214

(22) Filed: Nov. 17, 2017

(30) Foreign Application Priority Data
Jun. 19, 2017 (KR) 10-2017-0077413

(51) Int. Cl. G06F 21/32; H04L 29/06

(52) U.S. Cl. CPC G06F 21/32; H04L 63/0861

(57) ABSTRACT

A multi-modal based user authentication apparatus and method are provided. The multi-modal based user authentication apparatus includes a memory that stores whether user authentication is succeeded or failed; a processor that determines whether user authentication is succeeded or failed through user authentication; and a user authentication sensor unit that performs step (a) of measuring user bio signal information through a bio signal measurement sensor, step (b) of acquiring user bio recognition information through a bio recognition acquisition sensor, and step (c) of performing the user authentication by analyzing a correlation between the bio signal information and the bio recognition information.

### BACKGROUND OF THE INVENTION

### Technical Field

The present invention relates to user authentication technology using a bio signal, and more particularly, to a multi-modal based user authentication apparatus and method that can perform user authentication in which security is reinforced through correlation analysis between bio signal information and bio recognition information.

### Description of Related Art

User authentication technology based on bio recognition may determine similarity through comparison of sensor data acquired based on a biometric sensor or a bio signal sensor with original data at a database to authenticate a user with a method of determining whether the same person. In such conventional technology, because there is the difference in a result according to a state of a measuring person or a measurement environment, there is a drawback that reliability is somewhat is deteriorated and that security stability is weak in a counterfeit fingerprint attack such as paper and silicon.

Korean Patent Laid-Open Publication No. 10-2017-0034618 (Mar. 29, 2017) relates to a user authentication method using bio information, an authentication server for user authentication, and a bio recognition apparatus, and the user authentication method using bio information includes steps of collecting a user's first bio information, transmitting the first bio information to an authentication server, collecting the user's second bio information, and transmitting the second bio information to the authentication server when user authentication about first bio information is succeeded.

Korean Patent Publication No. 10-0875923 (Dec. 18, 2008) relates to a user search system and method for searching for a user by fusing recognition results of each single bio recognition system, and the user search system includes a bio information database that receives and stores an input of a plurality of bio information of a user; a distribution estimation unit that estimates a probability distribution using a cumulative distribution function of each bio information of the stored plurality of bio information; a bio information search unit that searches for a plurality of bio information of a search target user from the each bio information and that determines whether the bio information is matched to give a matching score to each information of a plurality of bio information of the target user; and a fusion unit that fuses the each matching score using Cumulative Bayes Fusion (CBF) with reference to the estimated probability distribution to extract the target user's search (authentication) result from a fusion result.

### PRIOR ART DOCUMENT

### Patent Document

Korean Patent Laid-Open Publication No. 10-2017-0034618 (Mar. 29, 2017)

Korean Patent Publication No. 10-0875923 (Dec. 18, 2008)

### SUMMARY OF THE INVENTION

The present invention has been made in view of the above problems and provides a multi-modal based user authentication apparatus and method that can perform user authentication in which security is reinforced through correlation analysis between bio signal information and bio recognition information.

The present invention further provides a multi-modal based user authentication apparatus and method that support limited allowance of user authentication according to a first authentication result of a bio signal and a second authentication result of bio recognition.

The present invention further provides a multi-modal based user authentication apparatus and method that can improve user identification accuracy even in a user state change.

In accordance with an aspect of the present invention, a multi-modal based user authentication apparatus includes a memory that stores whether user authentication is succeeded or failed; a processor that determines whether user authentication is succeeded or failed through user authentication; and a user authentication sensor unit that performs step (a) of measuring user bio signal information through a bio signal measurement sensor, step (b) of acquiring user bio recognition information through a bio recognition acquisition sensor, and step (c) of performing the user authentication by analyzing a correlation between the bio signal information and the bio recognition information.

The step (a) may include step (a1) of determining effectiveness by analyzing whether the measured bio signal information exists within an effective segment.

The step (a) may include step (a2) of analyzing the user state and dynamically adjusting at least one the upper limit and the lower limit for defining the effective segment according to the analyzed user state.

The step (c) may include step (c1) of extracting a first characteristic point related to a dynamic element from bio signal information determined to effective through the effectiveness determination; and step (c2) of extracting a second characteristic point related to a static element from the acquired bio recognition information.

The step (c) may include step (c3) of processing a weight value calculation of the first and second characteristic points in order of a fingerprint, a heart rate, and electrocardiogram in the first and second characteristic point extraction process.

The step (c) may include step (c4) of analyzing the correlation based on at least one of correlation tables of the positive and negative, a strength and weakness level, and a frequency distribution of a correlation representing between variables of the extracted first and second characteristic points.

The step (c) may include step (c5) of comparing and analyzing a vector calculation result calculated through a vector calculation between the extracted first and second characteristic points and a vector calculation reference result stored at the memory to analyze the correlation.

The step (a) may include step (a3) of regularly measuring the bio signal information in a specific time period.

The step (c) may include step (c6) of comparing and analyzing most recently measured bio signal information with user bio signal information stored at the memory to perform first authentication of the user.

The step (c) may include step (c7) of controlling to attempt, if the first authentication is not normally complete, remeasurement of the bio signal information by the specific limit number.

The step (b) may include step (b1) of acquiring, only when the first authentication is normally complete, user bio recognition information through the bio recognition acquisition sensor.

The step (c) may include step (c8) of limiting, when the first authentication is failed even after the remeasurement is attempted, execution of the user authentication for a predetermined time and transmitting a notification message that the first authentication is failed to a user terminal.

The step (c) may include step (c9) of comparing and analyzing, when the first authentication is failed even after the remeasurement is attempted, only the bio recognition information with user bio recognition information stored at the memory to control to perform second authentication of the user.

The step (c) may include step (c10) of limitedly allowing, if only the second authentication is normally complete, the user authentication result.

In accordance with another aspect of the present invention, a multi-modal based user authentication method is performed by a multi-modal based user authentication apparatus. The multi-modal based user authentication method includes steps of: measuring user bio signal information through a bio signal measurement sensor; acquiring user bio recognition information through a bio recognition acquisition sensor; and performing user authentication by analyzing a correlation between the bio signal information and the bio recognition information.

In accordance with another aspect of the present invention, a computer readable recording medium that can be executed by a computer that records a computer program on a multi-modal based user authentication method includes: a function of measuring user bio signal information through a bio signal measurement sensor; a function of acquiring user bio recognition information through a bio recognition acquisition sensor; and a function of performing user authentication by analyzing a correlation between the bio signal information and the bio recognition information.

### (Advantages)

Disclosed technology can have the following effects. However, it does not mean that a specific exemplary embodiment should include the entire following effects or should include only the following effects, and thus it should not be understood that the scope of disclosed technology is limited thereto.

A multi-modal based user authentication apparatus and method according to an exemplary embodiment of the present invention can perform user authentication in which security is reinforced through correlation analysis between bio signal information and bio recognition information.

A multi-modal based user authentication apparatus and method according to an exemplary embodiment of the present invention support limited allowance of user authentication according to a first authentication result of a bio signal and a second authentication result of bio recognition.

A multi-modal based user authentication apparatus and method according to an exemplary embodiment of the present invention can improve user identification accuracy even in a user state change.

### BRIEF DESCRIPTION OF THE DRAWINGS

FIG. 1 is a diagram illustrating a multi-modal based user authentication system according to an exemplary embodiment of the present invention.

FIG. 2 is a block diagram illustrating a configuration of a multi-modal based user authentication apparatus of FIG. 1.

FIG. 3 is a block diagram illustrating a configuration of a function element of a user authentication sensor unit of FIG. 2.

FIG. 4 is a flowchart illustrating a multi-modal based user authentication procedure performed by a user authentication sensor unit of FIG. 2.

FIGS. 5A and 5B are flowcharts illustrating an exemplary embodiment of a user authentication process in which a user authentication sensor unit of FIG. 2 determines whether user authentication is succeeded or failed through user authentication.

### DETAILED DESCRIPTION OF THE INVENTION

An exemplary embodiment of the present invention is merely an exemplary embodiment for a structural or functional description of the present invention and thus it should not be analyzed that the scope of the present invention is limited by an exemplary embodiment described in a detailed description. That is, because an exemplary embodiment may be variously changed and have several forms, it should be understood that the scope of the present invention include equivalents that can realize the spirit thereof. Further, it does not mean that a specific exemplary embodiment should include entire objects or effects suggested in the present invention or should include only such effects and thus it should not be understood that the scope of the present invention is limited thereto.

A meaning of terms described in an exemplary embodiment of the present invention should be understood as follows.

A term such as “first” and “second” is used for distinguishing a constituent element from another constituent element and the scope of the present invention is not limited by the terms. For example, a first constituent element may be referred to as a second constituent element and similarly, a second constituent element may be referred to as a first constituent element.

When it is described that a constituent element is “connected” or “electrically connected” to another constituent element, the element may be “directly connected” or “directly electrically connected” to the other constituent elements or may be “connected” or “electrically connected” to the other constituent elements through a third element. However, when it is described that a constituent element is “directly connected” or “directly electrically connected” to another constituent element, no element may exist between the element and the other element. Other expressions, i.e., “between” and “immediately between” or “adjacent to” and “directly adjacent to” describing a relationship between constituent elements should be similarly analyzed.

Singular forms used here include a plurality of forms unless phrases explicitly represent an opposite meaning, and a term of “comprising” or “having” used in a specification embodies a characteristic, number, step, operation, element, component, or combination thereof and does not exclude presence or addition of at least one characteristic, number, step, operation, element, component, or combination thereof.

In each step, identification symbols (e.g., a, b, and c) are used for convenience of description and do not describe order of each step, and unless each step does not clearly describe specific order in a context, the each step may occur differently from listed order. That is, each step may occur in the same order as listed order, may be substantially simultaneously performed, and may be performed in opposite order.

The present invention may be implemented with a computer readable code in a computer readable recording medium, and the computer readable recording medium includes all kinds of record devices that store data that can be read by a computer system. The computer readable recording medium may include, for example, a read-only memory (ROM), a random-access memory (RAM), a compact disc-ROM (CD-ROM), a magnetic tape, a floppy disk, and an optical data storage. Further, in the computer readable recording medium, computer readable codes that are distributed in a computer system connected to a network may be stored and executed with a distributed method.

Unless differently defined, all terms used here have the same meaning as a meaning that may be generally understood by a person of common skill in the art. It should be analyzed that terms defined in a generally using dictionary have a meaning corresponding with that of a context of related technology and are not analyzed as an ideal or excessively formal meaning unless explicitly defined in the present invention.

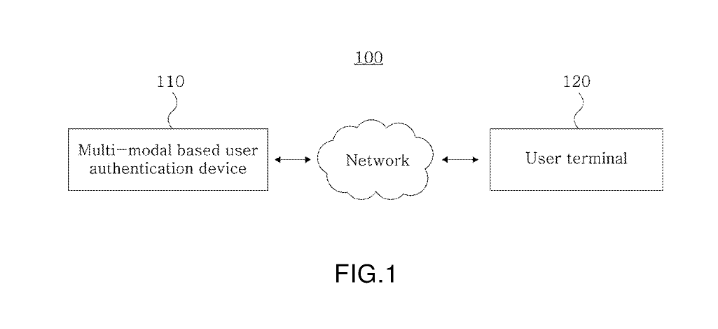

FIG. 1 is a diagram illustrating a multi-modal based user authentication system according to an exemplary embodiment of the present invention.

Referring to FIG. 1, a multi-modal based user authentication system 100 may include a multi-modal based user authentication device 110 and a user terminal 120.

The multi-modal based user authentication device 110 corresponds to a computing device that can perform user authentication based on multi-modal, and in an exemplary embodiment, the multi-modal based user authentication device 110 may be implemented into a wearable device such as an accessory type, a textile/clothing integral type, a body attachment type, or a body transplant type. In an exemplary embodiment, the multi-modal based user authentication device 110 may be connected to the user terminal 120 through a network and provide an execution result of user authentication to the user terminal 120.

The user terminal 120 corresponds to a computing device that may be connected to the multi-modal based user authentication device 110 through a network and may be implemented into, for example, a desktop computer, a notebook computer, a tablet personal computer (PC), or a smart phone. In an exemplary embodiment, the user terminal 120 may perform corresponding payment based on user authentication through interlocking with the multi-modal based user authentication device 110 in a payment process of a specific product performed on online. In an exemplary embodiment, the user terminal 120 may store user information necessary for user authentication based on bio information and provide user information stored in a user authentication execution process of the multi-modal based user authentication device 110 to the multi-modal based user authentication device 110, and here, the user information may include at least one of user bio signal information, bio recognition information, and a correlation between the bio signal information and the bio recognition information.

In an exemplary embodiment, the multi-modal based user authentication system 100 may further include a user management server (not shown), and the multi-modal based user authentication device 110 may be connected to the user terminal 120 through a user management server.

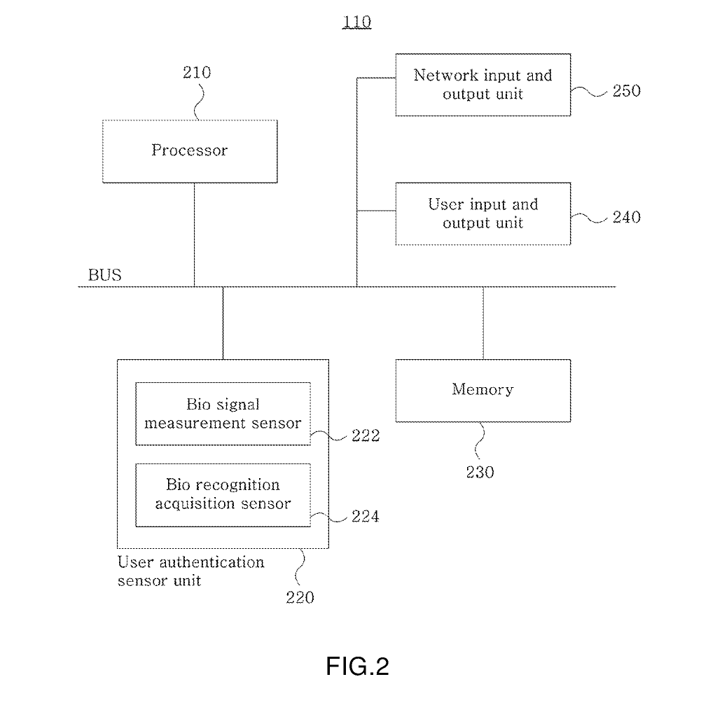

FIG. 2 is a block diagram illustrating a configuration of a multi-modal based user authentication apparatus of FIG. 1.

Referring to FIG. 2, the multi-modal based user authentication device 110 may include a processor 210, a user authentication sensor unit 220, a memory 230, a user input and output unit 240, and a network input and output unit 250.

The processor 210 may determine whether user authentication is succeeded or failed through user authentication. When a multi-modal based user authentication procedure is performed through the user authentication sensor unit 220, the processor 210 may process a calculation that determines whether user authentication is succeeded or failed based on a user authentication result according to a corresponding user authentication procedure and store whether user authentication is succeeded or failed at the memory 230. In an exemplary embodiment, when a user input related to user authentication is received through the user input and output unit 240 or when a user authentication request is received from the user terminal 120 to be related to a payment processor, the processor 210 may control the user authentication sensor unit 220 to start a user authentication process for user authentication and receive a user authentication result from the user authentication sensor unit 220 to process a calculation that determines whether user authentication is succeeded or failed. The processor 210 may manage the memory 230 that stores data read or written in a multi-modal based user authentication operation process and schedule a synchronization time between a volatile memory and a nonvolatile memory at the memory 230. The processor 210 may control an entire operation of the multi-modal based user authentication device 110, control data flow between the user authentication sensor unit 220, the memory 230, the user input and output unit 240, and the network input and output unit 250, and be implemented into a Central Processing Unit (CPU) of the multi-modal based user authentication device 110.

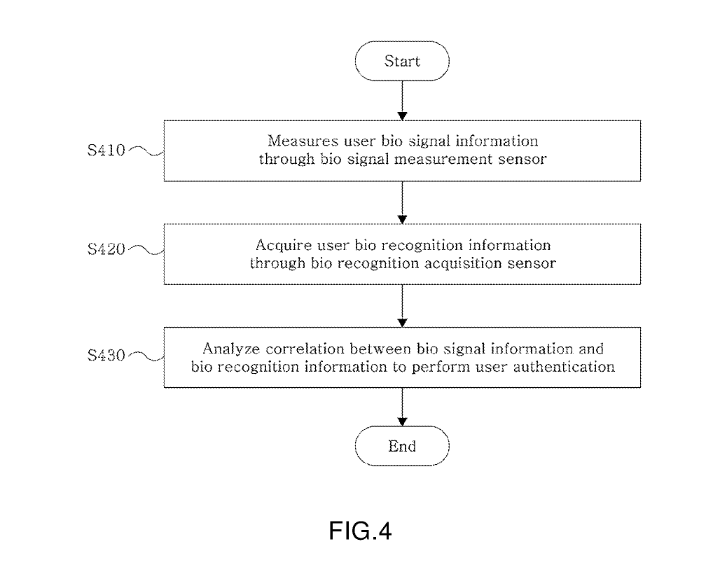

The user authentication sensor unit 220 may execute the multi-modal based user authentication procedure of FIG. 4. The user authentication sensor unit 220 may include a bio signal measurement sensor 222 and a bio recognition acquisition sensor 224. In an exemplary embodiment, the bio signal measurement sensor 222 may be implemented into a bio-signal sensor that can sense user bio signal information, and here, the bio signal information is information about a user electric, optical, or chemical bio signal and may include at least one of electrocardiogram (ECG) related to a heartbeat of a heart, electroencephalogram (EEG) related to an active state of cerebrum, electromyogram (EMG) related to an active state of a muscle, ballistocardiogram (BCG) related to a movement of a heartbeat, and photoplethysmogram (PPG) related to a vascular volume change in a body end portion. In an exemplary embodiment, the bio recognition acquisition sensor 224 may be implemented into a bio-metric sensor that can sense user bio recognition information, and here, the bio recognition information is a user individual intrinsic signal and may include at least one of fingerprint, iris, retina, and voice information.

In an exemplary embodiment, the user authentication sensor unit 220 may be implemented into a separate chip including a memory and a processor connected to the processor 210, but operating independently of other configuration units, and in another exemplary embodiment, the user authentication sensor unit 220 may be implemented to control an entire operation by the processor 210.

The memory 230 may include an auxiliary memory unit implemented with a nonvolatile memory such as a Solid State Disk (SSD) or a Hard Disk Drive (HDD) and used for storing entire data necessary for the multi-modal based user authentication device 110 and include a main memory unit implemented with a volatile memory such as a Random Access Memory (RAM). In this way, the memory 230 may be implemented into a volatile or nonvolatile memory, and when the memory 230 is implemented with a nonvolatile memory, the memory 230 may be connected through a hyperlink.

The memory 230 may include a user memory area related to user information, and in an exemplary embodiment, the user information may include a user identifier (name, ID, Internet Personal Identification Number, resident registration number, or phone number) and user bio information (may include at least one of bio signal information, bio recognition information, and a correlation between the bio signal information and the bio recognition information to be used as reference bio information in a user authentication process of a corresponding user). In an exemplary embodiment, the memory 230 may store whether user authentication determined through user authentication is succeeded or failed and include a user authentication memory area related to whether each user authentication is succeeded or failed. In an exemplary embodiment, the memory 230 may include a bio signal memory area related to regularly measured user bio signal information and a bio recognition memory area related to bio recognition information.

The user input and output unit 240 may include an environment for receiving a user input and an environment for outputting specific information to a user and include an input device including an adaptor such as, for example, a touch pad, a touchscreen, or a pointing device and an output device including an adaptor such as a monitor or a touchscreen.

The network input and output unit 250 may include an environment for connecting to the user terminal 120 through a network and include, for example, an adaptor for wireless Local Area Network (LAN) communication.

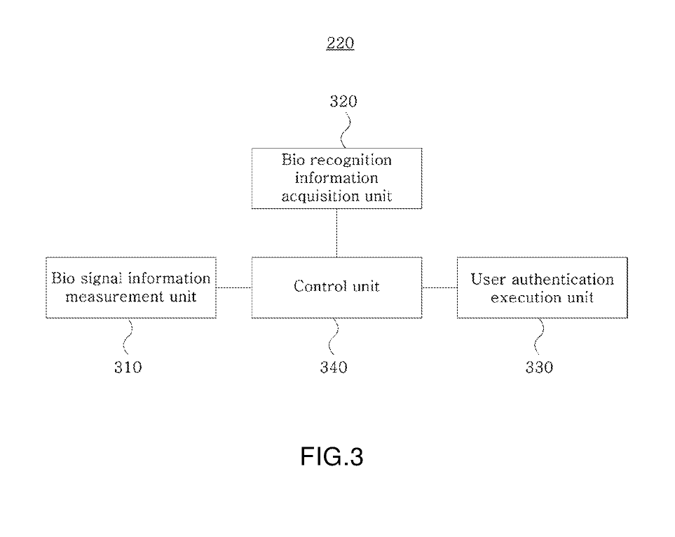

FIG. 3 is a block diagram illustrating a configuration of a function element of a user authentication sensor unit of FIG. 2.

Referring to FIG. 3, the user authentication sensor unit 220 may include a bio signal information measurement unit 310, a bio recognition information acquisition unit 320, a user authentication execution unit 330, and a control unit 340.

The bio signal information measurement unit 310 measures user bio signal information through the bio signal measurement sensor 222. In an exemplary embodiment, the bio signal information measurement unit 310 may sense a bio signal of at least one of corresponding user electric, mechanical, physical, optical, and chemical bio signals through the bio signal measurement sensor 222 attached to a user body surface or that contacts a user body surface to measure the bio signal into an electric signal. As described above, bio signal information may include at least one of ECG, EEG, EMG, BCG, and PPG.

The bio signal information measurement unit 310 may analyze whether measured bio signal information exists within an effective segment to determine effectiveness. In an exemplary embodiment, the bio signal information measurement unit 310 may store information about a value range, an area range, and a pattern range designated as a determination reference range of effectiveness of each of ECG, EEG, EMG, BCG, and PPG as an effective segment. In an exemplary embodiment, the effective segment may include a value range, an area range, or a pattern range of a bio signal in a general state excluding an excessive excited state or a severe tension state according to drinking or exercise. For example, when it is analyzed that user bio signal information measured during exercise or immediately after exercise is deviated from an effective segment, the bio signal information measurement unit 310 may determine that the corresponding bio signal information is not effective and not provide the corresponding bio signal information to the user authentication execution unit 330.

The bio signal information measurement unit 310 may analyze a user state and dynamically adjust at least one the upper limit and the lower limit for defining an effective segment according to an analyzed user state. In an exemplary embodiment, the bio signal information measurement unit 310 may compare and analyze measured user bio signal information based on an already stored reference value, reference area, and reference pattern, determine a corresponding user state to one of a static state, a general state, and a dynamic state, and perform dynamic adjustment that reduces, maintains or increases at least one the upper limit and the lower limit of at least one of a value range, an area range, and a pattern range at an effective segment according to each state relative to a reference value.

The bio signal information measurement unit 310 may regularly measure bio signal information in a specific time period. In an exemplary embodiment, while the bio signal measurement sensor 222 is attached to a user's body or maintains a contact with a user's body, the bio signal information measurement unit 310 may control the bio signal measurement sensor 222 to regularly sense a corresponding user bio signal information to collect corresponding bio signal information in a specific time period (e.g., in an interval of 10 seconds) and store the corresponding bio signal information at the memory 230, and when corresponding attachment or contact is released, the bio signal information measurement unit 310 may stop regular measurement.

In an exemplary embodiment, whenever the bio signal information measurement unit 310 performs regular measurement of bio signal information, the bio signal information measurement unit 310 may analyze a corresponding user state and adjust a specific time period that performs regular measurement to be slow or quick according to the analyzed user state. In an exemplary embodiment, the bio signal information measurement unit 310 may calculate an adjustment time period tₘ for performing regular measurement based on Equation 1 in consideration of a corresponding user state. For example, when a basic period value t₀ is 10 (s), if a user state analyzed in an execution process of regular measurement is a dynamic state (s=1), the bio signal information measurement unit 310 may calculate and reflect an adjustment time period tₘ for regular measurement of a next time to 1.25 (s), and if a user state analyzed in an execution process of regular measurement is a static state (s=3), the bio signal information measurement unit 310 may calculate and reflect an adjustment time period tₘ to 15 (s).

$${t}_{m} = {t}_{0} \times {( \frac{s}{2} )}^{\frac{3}{s}} \qquad [ Equation 1 ]$$

where s represents a state index according to an analyzed user state (3: static state, 2: general state, 1: dynamic state), and to represents a basic period value that may be set by a user or a designer.

The bio recognition information acquisition unit 320 acquires user bio recognition information through the bio recognition acquisition sensor 224.

In an exemplary embodiment, the bio recognition information acquisition unit 320 may sense bio recognition information of at least one of a corresponding user's body characteristic and action characteristic through the bio recognition acquisition sensor 224 that contacts a user body surface or disposed at a specific distance toward a specific body portion to acquire the bio recognition information into a digital signal. As described above, bio recognition information may include at least one of a fingerprint, an iris, a retina, a hand shape, a face, voice, and a signature.

The user authentication execution unit 330 analyzes a correlation between bio signal information and bio recognition information to perform user authentication. In an exemplary embodiment, the user authentication execution unit 330 may analyze a correlation between bio signal information and bio recognition information with a method of analyzing a correlation representing between variables of the bio signal information and the bio recognition information or representing between absolute amounts of the bio signal information and the bio recognition information. In an exemplary embodiment, the user authentication execution unit 330 may manage simultaneously obtained bio signal information and bio recognition information in a bio information pair.

The user authentication execution unit 330 may extract characteristic points from each of acquired bio signal information and bio recognition information and perform correlation analysis based on each extracted characteristic point. In an exemplary embodiment, the user authentication execution unit 330 may extract a first characteristic point related to a dynamic element from bio signal information determined to effective through effectiveness determination and extract a second characteristic point related to a static element from the acquired bio recognition information. In an exemplary embodiment, a dynamic element is represented in a bio signal and may correspond to a dynamic parameter of a bio signal characteristic in which data measured from a corresponding user according to a time or a situation may be generally changed, and a static element is represented in bio recognition information and may correspond to a static parameter of a bio recognition characteristic in which data measured from a corresponding user according to a time or a situation is not generally changed. In an exemplary embodiment, the user authentication execution unit 330 may include characteristic point extraction algorithm for extracting at least one characteristic point having high discrimination and a characteristic of each person and may extract at least one characteristic point from user bio information related to a user previously registered for user authentication and stored at the memory 230 and store corresponding information.

The user authentication execution unit 330 may perform a weight value calculation of first and second characteristic points in order of a fingerprint, a heart rate, and ECG in a first and second characteristic point extraction process. For example, when it is determined to effective, in a process of extracting a first characteristic point from bio signal information including a heart rate and ECG, by reflecting a first weight value to a heart rate and reflecting a second weight value lower than the first weight value to ECG, the user authentication execution unit 330 may extract a first characteristic point and thus a characteristic of a heart rate may be reflected to a higher priority. Here, each weight value may be adjusted by a user or a designer.

In an exemplary embodiment, the user authentication execution unit 330 may analyze a correlation between first and second characteristic points based on at least one of correlation tables of a positive and a negative, a strength and weakness level, and a frequency distribution of a correlation representing between variables of extracted first and second characteristic points. More specifically, the user authentication execution unit 330 may simultaneously acquire a pair of bio signal information and bio recognition information of a user (current user authentication target) through the bio signal information measurement unit 310 and the user authentication execution unit 330, acquire at least twice times such bio information pair at a specific time interval to collect a plurality of bio information pairs, and compare an analyzed correlation of a plurality of first and second characteristic point pairs extracted from the plurality of collected bio information pairs and a correlation stored to be related to a user (user previously registered for user authentication) stored at the memory 230 to determine similarity therebetween. For example, when a value of a first characteristic point extracted from bio signal information increases, if a value of a second characteristic point extracted from bio recognition information strongly increases, the user authentication execution unit 330 may determine that the characteristic points have a strong positive correlation and compare and analyze whether the correlation is similar to a stored correlation to determine whether user authentication is normal authentication or failure authentication.

In another exemplary embodiment, the user authentication execution unit 330 may compare and analyze a calculated vector calculation result of the extracted first and second characteristic points through a vector calculation and a vector calculation reference result stored at the memory 230 to analyze a correlation. More specifically, the user authentication execution unit 330 may represent a vector calculation result of first and second characteristic points in a vector graph to represent the vector calculation result at a specific location on a multidimensional coordinate plane, represent a plurality of vector calculation reference results corresponding to each of extracted first and second characteristic points among vector calculate information related to a user stored at the memory 230 on a corresponding coordinate plane, and analyze whether a corresponding vector calculation result approaches within a specific distance from a plurality of vector calculation reference results to exist within a specific correlation range and to determine whether user authentication is normal authentication or failure authentication.

The user authentication execution unit 330 may separately perform user first authentication and second authentication. Here, the first authentication is authentication on whether user bio signal information corresponds and may correspond to primarily performed user authentication, and the second authentication is authentication on whether user bio recognition information corresponds and may correspond to secondarily performed user authentication following the first authentication.

The user authentication execution unit 330 may compare and analyze most recently measured bio signal information with user bio signal information stored at the memory 230 to perform user first authentication. In an exemplary embodiment, when a user authentication process is started, the user authentication execution unit 330 may compare and analyze most recently measured bio signal information among bio signal information of a user (current user authentication target) regularly measured and stored through the bio signal measurement sensor 222 with bio signal information in user bio information related to a user (user previously registered for user authentication) stored at the memory 230 in a value range, an area range, and a pattern range to calculate a matching level between the two bio signal information, and when the calculated matching level is equal to or larger than a predetermined reference matching level (e.g., 90%), the user authentication execution unit 330 may determine that corresponding user bio signal information corresponds with registered user bio signal information in a considerable level to process a result of first authentication of a corresponding user to normal completion.

In an exemplary embodiment, when first authentication of a user is not normally complete, the user authentication execution unit 330 may control to attempt remeasurement of corresponding bio signal information by the specific limit number (e.g., three times), and even after corresponding remeasurement, when corresponding first authentication is not normally complete, the user authentication execution unit 330 may stop user authentication. In this case, only when first authentication of the user is normally complete by the bio signal information measurement unit 310, the bio recognition information acquisition unit 320 may acquire corresponding user bio recognition information through the bio recognition acquisition sensor 224. Only when first authentication related to a bio signal is normally authenticated, the user authentication execution unit 330 may control to perform correlation analysis and execution of second authentication related to bio recognition at subsequent steps to perform user authentication in which security is more reinforced. Even after such remeasurement is attempted, when first authentication is failed, the user authentication execution unit 330 may limit execution of user authentication for a predetermined time and transmit a notification message on a failure of first authentication to the user terminal 120.

In another exemplary embodiment, even after remeasurement of bio signal information is attempted by the bio signal information measurement unit 310, when first authentication of a corresponding user is failed, the user authentication execution unit 330 may compare and analyze only bio recognition information with user bio recognition information stored at the memory 230 to control to perform second authentication of the corresponding user. In this case, even if final first authentication is failed, the bio recognition information acquisition unit 320 may acquire bio recognition information through the bio recognition acquisition sensor 224, and the user authentication execution unit 330 may compare and analyze acquired bio recognition information and bio recognition information stored at the memory 230 and perform second authentication of a corresponding user through calculation of a matching level between the two bio signal information and comparison calculation with a reference matching level to process a corresponding second authentication result to normal completion or failure.

In the above exemplary embodiment, when only second authentication is normally complete, the user authentication execution unit 330 may limitedly allow a user authentication result. For example, when the entire of first and second authentication of a user and user authentication through correlation analysis is normal completion processed, the user authentication execution unit 330 may allow the entire user authority through corresponding user authentication, and when first authentication is failed and when only second authentication is normal completion processed, the user authentication execution unit 330 may allow only a portion of a user authority through corresponding user authentication. Here, an authority range corresponding to a portion of a user authority may be determined by a payment/approval request institute, a designer, or a user (previously registered user for user authentication) related to corresponding user authentication.

The control unit 340 may control an entire operation of the user authentication sensor unit 220 and control data flow between the bio signal information measurement unit 310, the bio recognition information acquisition unit 320, and the user authentication execution unit 330. In an exemplary embodiment, the control unit 340 may be implemented with a central processing unit (CPU) of the user authentication sensor unit 220.

FIG. 4 is a flowchart illustrating a multi-modal based user authentication procedure performed by a user authentication sensor unit of FIG. 2.

Referring to FIG. 4, the bio signal information measurement unit 310 measures user bio signal information through the bio signal measurement sensor 222 (step S410). The bio recognition information acquisition unit 320 acquires the user bio recognition information through the bio recognition acquisition sensor 224 (step S420). The user authentication execution unit 330 analyzes a correlation between bio signal information and bio recognition information to perform user authentication (step S430).

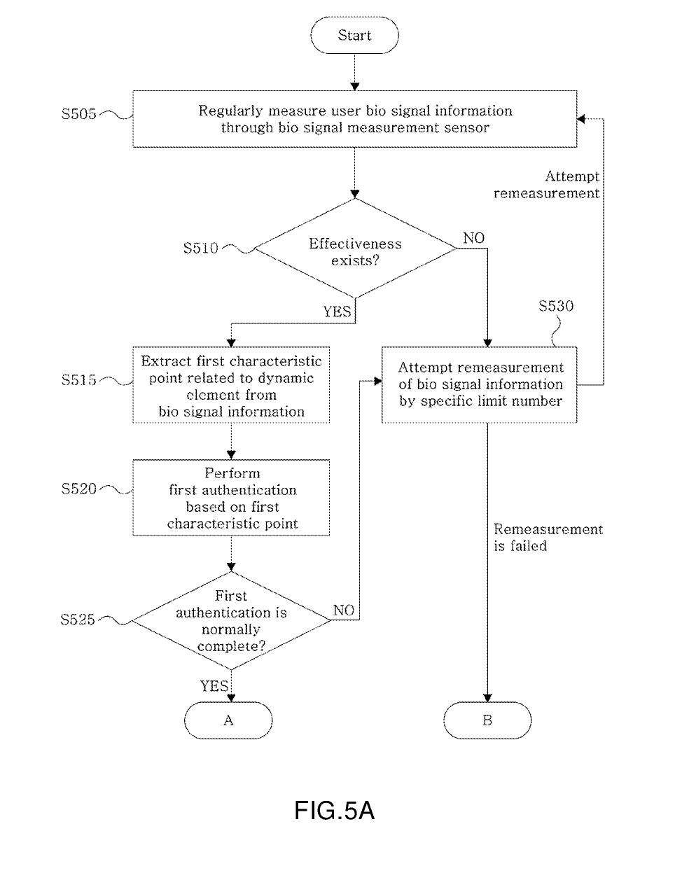

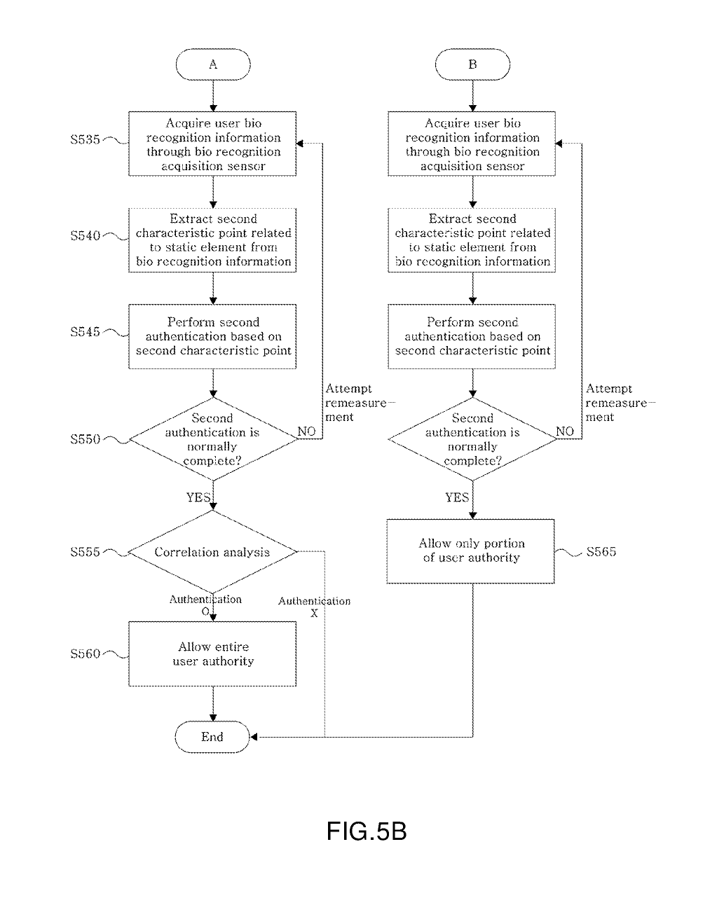

FIG. 5 is a flowchart illustrating an exemplary embodiment of a user authentication process in which a user authentication sensor unit of FIG. 2 determines whether user authentication is succeeded or failed through user authentication.

Referring to FIGS. 5A to 5B, the bio signal information measurement unit 310 may regularly measure bio signal information through the bio signal measurement sensor 222 in a specific time period (step S505). The bio signal information measurement unit 310 may analyze whether most recently measured bio signal information exists within an effective segment to determine effectiveness (step S510).

If corresponding bio signal information is effective according to effectiveness determination, the bio signal information measurement unit 310 may extract a first characteristic point related to a dynamic element from the corresponding bio signal information (step S515). The user authentication execution unit 330 may perform first authentication of a corresponding user based on the extracted first characteristic point (step S520) and compare and analyze the extracted first characteristic point and a reference characteristic point extracted from user signal information in user bio information stored at the memory 230 to determine whether a corresponding user's first authentication result is normal completion processed according to whether a matching level between the characteristic points is equal to or larger than a reference matching level (step S525).

If first authentication is not normally complete, the bio signal information measurement unit 310 may attempt remeasurement of bio signal information by the specific limit number through the bio signal measurement sensor 222 (step S530). If first authentication result is normally complete, the bio recognition information acquisition unit 320 may acquire the user bio recognition information through the bio recognition acquisition sensor 224 (step S535).

The user authentication execution unit 330 may extract a second characteristic point related to a static element from the acquired bio recognition information (step S540), compare and analyze the extracted second characteristic point and a reference characteristic point extracted from bio recognition information in user bio information stored at the memory 230 to perform second authentication (step S545), and determine whether a second authentication result of a corresponding user is normal completion processed according to whether a matching level between the characteristic points is equal to or larger than a reference matching level (step S550).

If second authentication is not normally complete, the user authentication execution unit 330 may control to attempt remeasurement of bio recognition information by the specific limit number through the bio recognition acquisition sensor 224 (step S550), and if second authentication is normally complete, the user authentication execution unit 330 may perform correlation analysis based on the extracted first and second characteristic point (step S555). If user authentication is succeeded, the user authentication execution unit 330 may perform a normal completion processing of a corresponding user authentication result through correlation analysis, thereby allowing the entire user authority through corresponding user authentication (step S560).

If corresponding bio signal information is not effective according to effectiveness determination at step S510, the bio signal information measurement unit 310 may attempt remeasurement of bio signal information through the bio signal measurement sensor 222 by the specific limit number (step S530), and when remeasurement is finally failed, the bio signal information measurement unit 310 may perform second authentication of the user through the same process as that of steps S535-S550. Thereafter, when second authentication is normally complete, first authentication is failed and only second authentication is normally completion processed and thus the bio signal information measurement unit 310 may determine to allow only a portion of user authority through corresponding user authentication (step S565).

Although exemplary embodiments of the present disclosure have been described in detail hereinabove, it should be clearly understood that many variations and modifications of the basic inventive concepts herein described, which may appear to those skilled in the art, will still fall within the spirit and scope of the exemplary embodiments of the present disclosure as defined in the appended claims.

What is claimed is:

1. A multi-modal based user authentication apparatus, comprising:
a memory that stores whether user authentication is succeeded or failed;
a processor that determines whether user authentication is succeeded or failed through user authentication; and
a user authentication sensor unit that performs step (a) of measuring user bio signal information through a bio signal measurement sensor, step (b) of acquiring user bio recognition information through a bio recognition acquisition sensor, and step (c) of performing the user authentication by analyzing a correlation between the bio signal information and the bio recognition information.

2. The multi-modal based user authentication apparatus of claim 1, wherein the step (a) comprises step (a1) of determining effectiveness by analyzing whether the measured bio signal information exists within an effective segment.

3. The multi-modal based user authentication apparatus of claim 2, wherein the step (a) comprises step (a2) of analyzing the user state and dynamically adjusting at least one the upper limit and the lower limit for defining the effective segment according to the analyzed user state.

4. The multi-modal based user authentication apparatus of claim 2, wherein the step (c) comprises:
step (c1) of extracting a first characteristic point related to a dynamic element from bio signal information determined to effective through the effectiveness determination; and
step (c2) of extracting a second characteristic point related to a static element from the acquired bio recognition information.

5. The multi-modal based user authentication apparatus of claim 4, wherein the step (c) comprises step (c3) of processing a weight value calculation of the first and second characteristic points in order of a fingerprint, a heart rate, and electrocardiogram in the first and second characteristic point extraction process.

6. The multi-modal based user authentication apparatus of claim 4, wherein the step (c) comprises step (c4) of analyzing the correlation based on at least one of correlation tables of the positive and negative, a strength and weakness level, and a frequency distribution of a correlation representing between variables of the extracted first and second characteristic points.

7. The multi-modal based user authentication apparatus of claim 4, wherein the step (c) comprises step (c5) of comparing and analyzing a vector calculation result calculated through a vector calculation between the extracted first and second characteristic points and a vector calculation reference result stored at the memory to analyze the correlation.

8. The multi-modal based user authentication apparatus of claim 1, wherein the step (a) comprises step (a3) of regularly measuring the bio signal information in a specific time period.

9. The multi-modal based user authentication apparatus of claim 8, wherein the step (c) comprises step (c6) of comparing and analyzing most recently measured bio signal information with user bio signal information stored at the memory to perform first authentication of the user.

10. The multi-modal based user authentication apparatus of claim 9, wherein the step (c) comprises step (c7) of controlling to attempt, if the first authentication is not normally complete, remeasurement of the bio signal information by the specific limit number.

11. The multi-modal based user authentication apparatus of claim 10, wherein the step (b) comprises step (b1) of acquiring, only when the first authentication is normally complete, user bio recognition information through the bio recognition acquisition sensor.

12. The multi-modal based user authentication apparatus of claim 10, wherein the step (c) comprises step (c8) of limiting, when the first authentication is failed even after the remeasurement is attempted, execution of the user authentication for a predetermined time and transmitting a notification message that the first authentication is failed to a user terminal.

13. The multi-modal based user authentication apparatus of claim 10, wherein the step (c) comprises step (c9) of comparing and analyzing, when the first authentication is failed even after the remeasurement is attempted, only the bio recognition information with user bio recognition information stored at the memory to control to perform second authentication of the user.

14. The multi-modal based user authentication apparatus of claim 13, wherein the step (c) comprises step (c10) of limitedly allowing, if only the second authentication is normally complete, the user authentication result.

15. A multi-modal based user authentication method performed by a multi-modal based user authentication apparatus, the multi-modal based user authentication method comprising:
measuring user bio signal information through a bio signal measurement sensor;
acquiring user bio recognition information through a bio recognition acquisition sensor; and
performing user authentication by analyzing a correlation between the bio signal information and the bio recognition information.

16. A computer readable recording medium that can be executed by a computer that records a computer program on a multi-modal based user authentication method comprising:
a function of measuring user bio signal information through a bio signal measurement sensor;
a function of acquiring user bio recognition information through a bio recognition acquisition sensor; and
a function of performing user authentication by analyzing a correlation between the bio signal information and the bio recognition information.
